(19) United States
(12) Patent Application Publication
(10) Pub. No.: US 2024/0184581 A1
(43) Pub. Date: Jun. 6, 2024

(54) BIT PATTERN MATCHING HARDWARE PREFETCHER

(71) Applicant: SiFive, Inc., San Mateo, CA (US)

(72) Inventors: Benoy Alexander, Cedar Park, TX (US); John Ingalls, Mountain View, CA (US); Binayak Tiwari, Las Vegas, NV (US)

(21) Appl. No.: 18/497,170

(22) Filed: Oct. 30, 2023

Related U.S. Application Data
(60) Provisional application No. 63/429,880, filed on Dec. 2, 2022.

(51) Int. Cl. G06F 9/30; G06F 9/38

(52) U.S. Cl. CPC G06F 9/30047; G06F 9/3816; G06F 9/3836

(57) ABSTRACT

Described herein is a bit pattern matching hardware prefetcher which captures complex repeating patterns, allows out-of-order (OOO) training, and allows OOO confirmations. The prefetcher includes a plurality of prefetch engines. Each prefetch engine is associated with a zone, each zone has a plurality of subzones, and each subzone has a plurality of cache lines. The prefetcher includes an access map for each subzone. Each bit position represents a cache line in the plurality of cache lines. The prefetcher determines whether a demand request matches one of the plurality of prefetch engines, updates, with respect to the demand request, a bit position in an access map for a subzone in a matching prefetch engine, determines a pattern from an access map for a subzone when a defined number of demand requests have been matched to the subzone; and generates a prefetch request based on at least the determined pattern.

### CROSS REFERENCE TO RELATED APPLICATION

This application claims priority to and the benefit of U.S. Provisional Patent Application Ser. No. 63/429,880 filed on Dec. 2, 2022, the entire disclosure of which is hereby incorporated by reference.

### TECHNICAL FIELD

This disclosure relates to a prefetcher.

### BACKGROUND

A prefetcher is used to retrieve data into a cache memory prior to being used by a core, to improve the throughput of the core. The prefetcher performs accesses to memory based on patterns of data accesses or requests made by the core. The data accesses may be specific to a hardware thread of an application executing in the core. For example, a hardware thread is reading every 64th byte of a large array and the accesses are missing in a level 1 (L1) cache. In implementations, the prefetcher is a hardware prefetcher. A stride-type hardware prefetcher will detect these misses, determine a single stride of 64 bytes, and send a prefetch request accordingly. The prefetcher can monitor multiple data streams per hardware thread. Prefetches are automatically issued to the memory system when possible. This reduces overall access time to the array and improves the performance of the application.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an example block diagram of a system for facilitating generation and manufacture of integrated circuits.

FIG. 2 is an example block diagram of a system for facilitating generation of a circuit representation.

FIG. 3 is an example block diagram of an integrated circuit with a bit pattern matching hardware prefetcher.

FIG. 4 is an example block diagram of a system with a bit pattern matching hardware prefetcher (BPM HWPF).

FIG. 5A is an example block diagram of a memory space.

FIG. 5B is an example block diagram of a prefetch engine associated with a zone.

FIGS. 6A and 6B are examples of block diagrams of a bitmap structure per zone.

FIGS. 7A and 7B are example block diagrams of a bitmap structure per subzone.

FIG. 8 is an example state diagram for a cache line.

FIG. 9 is an example block diagram showing a load/store pipeline and a BPM HWPF pipeline.

FIG. 10 is an example block diagram of the BPM HWPF pipeline.

FIGS. 11A and 11B are example block diagrams of leading edge determinations.

FIG. 12 is an example block diagram for finding a repeating pattern.

FIG. 13 is an example flow for pattern selection.

FIG. 14 is an example block diagram for sending prefetch requests and getting confirmations based on found pattern.

### DETAILED DESCRIPTION

Described herein is a prefetcher, namely, a bit pattern matching (BPM) hardware prefetcher (HWPF) which captures complex repeating patterns, allows out-of-order (OOO) training, and allows OOO confirmations which will not unlock the BPM HWPF. The BPM HWPF looks for repeating patterns that are not necessarily single stride (e.g., +64B, +128B, etc) such as, for example, complex spatial patterns (e.g., +64B, +128B, +64B, +128B, etc). The BPM HWPF also confirms a prefetch when a demand request accesses the same location. The BPM HWPF integrates a single-level prefetching scheme with dynamic distance.

Pattern detection in the BPM HWPF is amenable to OOO execution by collecting recently accessed memory addresses and applying a pattern detection algorithm to the collected accessed memory addresses. In implementations, the BPM HWPF uses a bitmap structure to enable OOO training and confirmation. The memory address space is divided into zones where a certain number of cache lines are mapped. A bitmap structure is maintained where each cache line from the zone has an entry that records the past memory accesses. The past access pattern is analyzed by the pattern matching logic to identify the pattern for potential future prefetching.

In implementations, demand requests and/or program accesses are captured in an area-efficient manner using a pair of bit vectors: a program access vector or access map, and a prefetch vector or prefetch map. As program access is executed, the BPM HWPF will track the pattern in the access map (last program accesses) where each bit in the vector represents a cache line. The access map is then analyzed by the pattern detection algorithm which determines the direction of the stream and then looks for repeated back-to-back patterns of N-bits. Once a pattern is found, then the BPM HWPF will start prefetching the next set of predicted addresses based on the pattern. This will continue and as demand requests confirm prefetches which were set, the prefetch distance is dynamically increased.

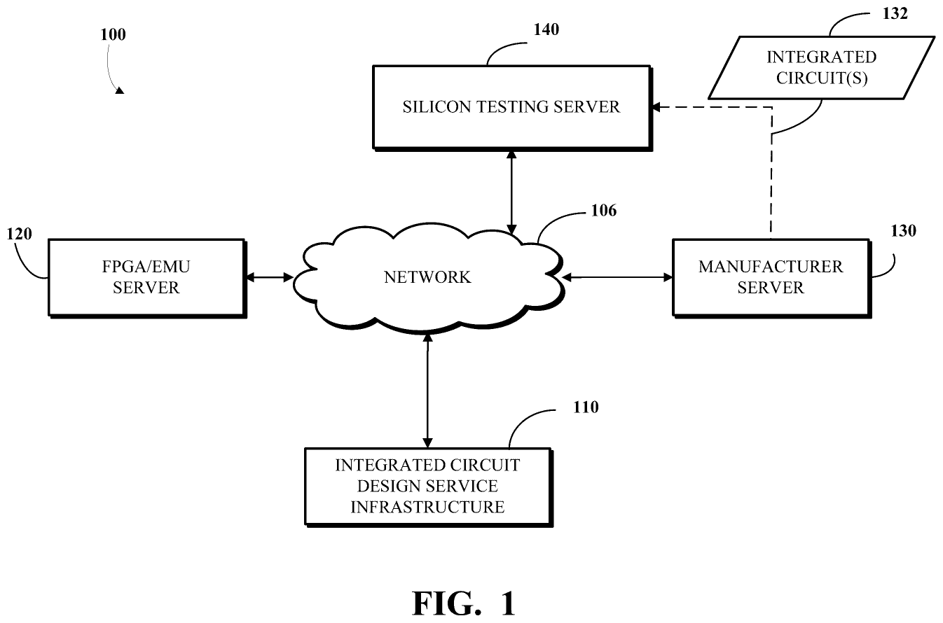

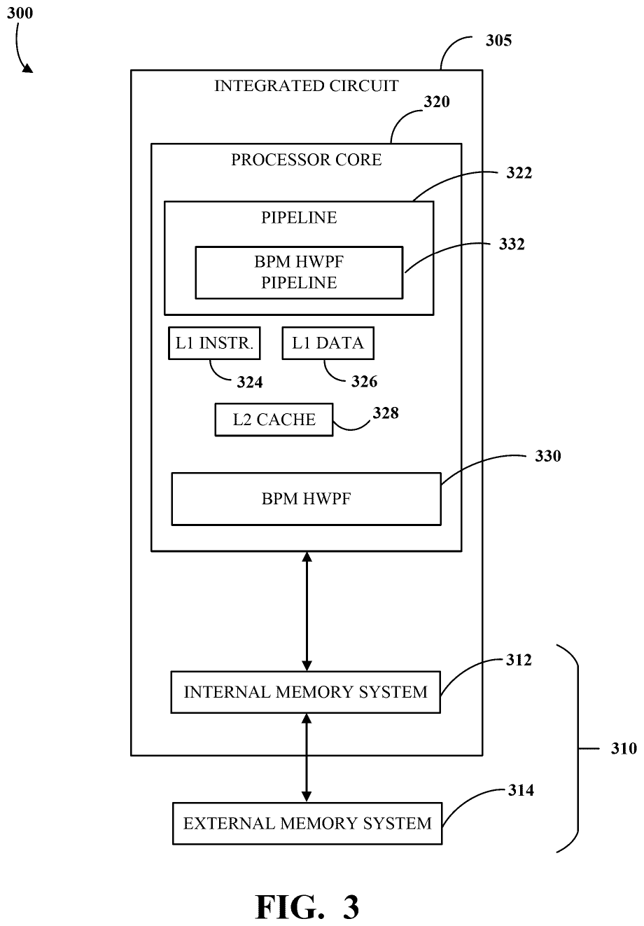

To describe some implementations in greater detail, reference is first made to examples of hardware and software structures used to implement a system including components that may provide a BPM HWPF. FIG. 1 is a block diagram of an example of a system 100 for generation and manufacture of integrated circuits. The system 100 includes a network 106, an integrated circuit design service infrastructure 110 (e.g., integrated circuit generator), a field programmable gate array (FPGA)/emulator server 120, and a manufacturer server 130. For example, a user may utilize a web client or a scripting application program interface (API) client to command the integrated circuit design service infrastructure 110 to automatically generate an integrated circuit design based on a set of design parameter values selected by the user for one or more template integrated circuit designs. In some implementations, the integrated circuit design service infrastructure 110 may be configured to generate an integrated circuit design like the integrated circuit design shown and described in FIGS. 3-10 and 13.

The integrated circuit design service infrastructure 110 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using flexible intermediate representation for register-transfer level (FIRRTL) and/or a FIRRTL compiler. For example, the RTL service module may be implemented using Diplomacy. For example, the RTL service module may enable a well-designed chip to be automatically developed from a high level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 110 may invoke (e.g., via network communications over the network 106) testing of the resulting design that is performed by the FPGA/emulation server 120 that is running one or more FPGAs or other types of hardware or software emulators. For example, the integrated circuit design service infrastructure 110 may invoke a test using a field programmable gate array, programmed based on a field programmable gate array emulation data structure, to obtain an emulation result. The field programmable gate array may be operating on the FPGA/emulation server 120, which may be a cloud server. Test results may be returned by the FPGA/emulation server 120 to the integrated circuit design service infrastructure 110 and relayed in a useful format to the user (e.g., via a web client or a scripting API client).

The integrated circuit design service infrastructure 110 may also facilitate the manufacture of integrated circuits using the integrated circuit design in a manufacturing facility associated with the manufacturer server 130. In some implementations, a physical design specification (e.g., a graphic data system (GDS) file, such as a GDSII file) based on a physical design data structure for the integrated circuit is transmitted to the manufacturer server 130 to invoke manufacturing of the integrated circuit (e.g., using manufacturing equipment of the associated manufacturer). For example, the manufacturer server 130 may host a foundry tape-out website that is configured to receive physical design specifications (e.g., such as a GDSII file or an open artwork system interchange standard (OASIS) file) to schedule or otherwise facilitate fabrication of integrated circuits. In some implementations, the integrated circuit design service infrastructure 110 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 110 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 130 may fabricate and/or test integrated circuits based on the integrated circuit design. For example, the associated manufacturer (e.g., a foundry) may perform optical proximity correction (OPC) and similar post-tape-out/pre-production processing, fabricate the integrated circuit(s) 132, update the integrated circuit design service infrastructure 110 (e.g., via communications with a controller or a web application server) periodically or asynchronously on the status of the manufacturing process, perform appropriate testing (e.g., wafer testing), and send to a packaging house for packaging. A packaging house may receive the finished wafers or dice from the manufacturer and test materials and update the integrated circuit design service infrastructure 110 on the status of the packaging and delivery process periodically or asynchronously. In some implementations, status updates may be relayed to the user when the user checks in using the web interface, and/or the controller might email the user that updates are available.

In some implementations, the resulting integrated circuit(s) 132 (e.g., physical chips) are delivered (e.g., via mail) to a silicon testing service provider associated with a silicon testing server 140. In some implementations, the resulting integrated circuit(s) 132 (e.g., physical chips) are installed in a system controlled by the silicon testing server 140 (e.g., a cloud server), making them quickly accessible to be run and tested remotely using network communications to control the operation of the integrated circuit(s) 132. For example, a login to the silicon testing server 140 controlling a manufactured integrated circuit(s) 132 may be sent to the integrated circuit design service infrastructure 110 and relayed to a user (e.g., via a web client). For example, the integrated circuit design service infrastructure 110 may be used to control testing of one or more integrated circuit(s) 132.

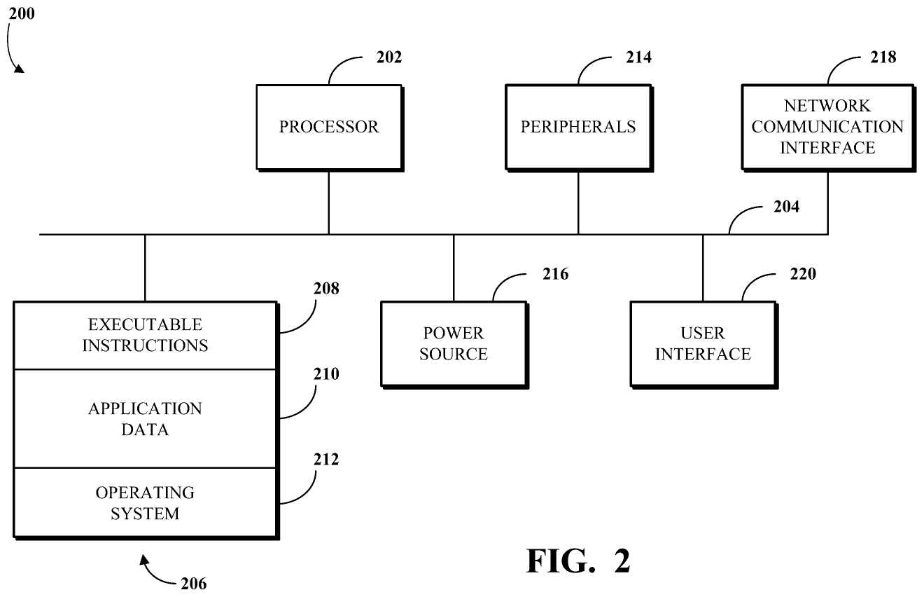

FIG. 2 is a block diagram of an example of a system 200 for facilitating generation of integrated circuits, for facilitating generation of a circuit representation for an integrated circuit, and/or for programming or manufacturing an integrated circuit. The system 200 is an example of an internal configuration of a computing device. The system 200 may be used to implement the integrated circuit design service infrastructure 110, and/or to generate a file that generates a circuit representation of an integrated circuit design like the integrated circuit design shown and described in FIGS. 3-10 and 13.

The processor 202 can be a central processing unit (CPU), such as a microprocessor, and can include single or multiple processors having single or multiple processing cores. Alternatively, the processor 202 can include another type of device, or multiple devices, now existing or hereafter developed, capable of manipulating or processing information. For example, the processor 202 can include multiple processors interconnected in any manner, including hardwired or networked, including wirelessly networked. In some implementations, the operations of the processor 202 can be distributed across multiple physical devices or units that can be coupled directly or across a local area or other suitable type of network. In some implementations, the processor 202 can include a cache, or cache memory, for local storage of operating data or instructions.

The memory 206 can include volatile memory, non-volatile memory, or a combination thereof. For example, the memory 206 can include volatile memory, such as one or more dynamic random access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 206 can include another type of device, or multiple devices, now existing or hereafter developed, capable of storing data or instructions for processing by the processor 202. The processor 202 can access or manipulate data in the memory 206 via the bus 204. Although shown as a single block in FIG. 2, the memory 206 can be implemented as multiple units. For example, a system 200 can include volatile memory, such as random access memory (RAM), and persistent memory, such as a hard drive or other storage.

The memory 206 can include executable instructions 208, data, such as application data 210, an operating system 212, or a combination thereof, for immediate access by the processor 202. The executable instructions 208 can include, for example, one or more application programs, which can be loaded or copied, in whole or in part, from non-volatile memory to volatile memory to be executed by the processor 202. The executable instructions 208 can be organized into programmable modules or algorithms, functional programs, codes, code segments, or combinations thereof to perform various functions described herein. For example, the executable instructions 208 can include instructions executable by the processor 202 to cause the system 200 to automatically, in response to a command, generate an integrated circuit design and associated test results based on a design parameters data structure. The application data 210 can include, for example, user files, database catalogs or dictionaries, configuration information or functional programs, such as a web browser, a web server, a database server, or a combination thereof. The operating system 212 can be, for example, Microsoft Windows®, macOS®, or Linux®; an operating system for a small device, such as a smartphone or tablet device; or an operating system for a large device, such as a mainframe computer. The memory 206 can comprise one or more devices and can utilize one or more types of storage, such as solid-state or magnetic storage.

The peripherals 214 can be coupled to the processor 202 via the bus 204. The peripherals 214 can be sensors or detectors, or devices containing any number of sensors or detectors, which can monitor the system 200 itself or the environment around the system 200. For example, a system 200 can contain a temperature sensor for measuring temperatures of components of the system 200, such as the processor 202. Other sensors or detectors can be used with the system 200, as can be contemplated. In some implementations, the power source 216 can be a battery, and the system 200 can operate independently of an external power distribution system. Any of the components of the system 200, such as the peripherals 214 or the power source 216, can communicate with the processor 202 via the bus 204.

The network communication interface 218 can also be coupled to the processor 202 via the bus 204. In some implementations, the network communication interface 218 can comprise one or more transceivers. The network communication interface 218 can, for example, provide a connection or link to a network, such as the network 106 shown in FIG. 1, via a network interface, which can be a wired network interface, such as Ethernet, or a wireless network interface. For example, the system 200 can communicate with other devices via the network communication interface 218 and the network interface using one or more network protocols, such as Ethernet, transmission control protocol (TCP), Internet protocol (IP), power line communication (PLC), Wi-Fi, infrared, general packet radio service (GPRS), global system for mobile communications (GSM), code division multiple access (CDMA), or other suitable protocols.

A user interface 220 can include a display; a positional input device, such as a mouse, touchpad, touchscreen, or the like; a keyboard; or other suitable human or machine interface devices. The user interface 220 can be coupled to the processor 202 via the bus 204. Other interface devices that permit a user to program or otherwise use the system 200 can be provided in addition to or as an alternative to a display. In some implementations, the user interface 220 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 214. The operations of the processor 202 can be distributed across multiple clients or servers, which can be coupled directly or across a local area or other suitable type of network. The memory 206 can be distributed across multiple clients or servers, such as network-based memory or memory in multiple clients or servers performing the operations of clients or servers. Although depicted here as a single bus, the bus 204 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

FIG. 3 is a block diagram of an example of a system 300 including an integrated circuit 305 and a memory system 310. The integrated circuit 305 may include a processor core 320. The integrated circuit 305 could be implemented, for example, as a field-programmable gate array (FPGA), an application-specific integrated circuit (ASIC), or a system-on-chip (SoC). The memory system 310 may include an internal memory system 312 and an external memory system 314. The internal memory system 312 may be in communication with the external memory system 314. The internal memory system 312 may be internal to the integrated circuit 305 (e.g., implemented by the FPGA, the ASIC, or the SoC). The external memory system 314 may be external to integrated circuit 305 (e.g., not implemented by the FPGA, the ASIC, or the SoC). The internal memory system 312 may include, for example, a controller and memory, such as random access memory (RAM), static random access memory (SRAM), cache, and/or a cache controller, such as a level three (L3) cache and an L3 cache controller. The external memory system 314 may include, for example, a controller and memory, such as dynamic random access memory (DRAM) and a memory controller. In some implementations, the memory system 310 may include memory mapped inputs and outputs (MMIO), and may be connected to non-volatile memory, such as a disk drive, a solid-state drive, flash memory, and/or phase-change memory (PCM).

The processor core 320 may include circuitry for executing instructions, such as one or more pipelines 322, a level one (L1) instruction cache 324, an L1 data cache 326, and a level two (L2) cache 328 that may be a shared cache. The processor core 320 may fetch and execute instructions in the one or more pipelines 322, for example, as part of a program sequence. The instructions may cause memory requests (e.g., read requests and/or write requests) that the one or more pipelines 322 may transmit to the L1 instruction cache 324, the L1 data cache 326, and/or the L2 cache 328. Each of the one or more pipelines 322 may include a primary pipeline and a vector pipeline. The primary pipeline and the vector pipeline can each have separate decode units, rename units, dispatch units, execution units, physical and/or virtual registers, caches, queues, data paths, and/or other logic associated with instruction flow. In some implementations, the primary pipeline and the vector pipeline may be out-of-order pipelines.

In implementations, the processor core 320 may include an BPM HWPF 330 integrated with the processor core 320. In implementations, the integrated circuit 305 may include a BPM HWPF 330 connected to or in communication with (collectively “connected to”) the processor core 320. The BPM HWPF 330 can include a BPM HWPF pipeline 332. The BPM HWPF 330, via the BPM HWPF pipeline 332, can be used to collect a window of demand requests, program accesses, and/or memory accesses (collectively “demand requests”) which miss in a cache, such as the L1 instruction cache 324 or the L1 data cache 326. A pair of bit vectors can track states of cache lines. A bit can be set (or cleared based on implementation) in an access map to indicate an access, where each bit represents a cache line. After receiving a defined number of demand requests, the access map can be analyzed to detect an access pattern. A prefetch request can be generated and sent accordingly. A bit can be set (or cleared based on implementation) in a prefetch map to indicate a prefetch request, where each bit represents a cache line. Confirmations can be determined based on the access map and the prefetch map. In implementations, a confirmation can occur when a demand request accesses a cache line for which a prefetch request had been generated and sent. In implementations, a confirmation can also occur when a prefetch request has been generated for a cache line for which a demand request had already been received. This is a good prefetch but a late prefetch. In implementations, this late prefetch request is not sent or dispatched. Confirmation(s) can be used to control an aggressiveness of the BPM HWPF 330. That is, a dynamic distance can be adjusted based on the confirmation(s).

The system 300 and each component in the system 300 is illustrative and can include additional, fewer, or different components which may be similarly or differently architected without departing from the scope of the specification and claims herein. Moreover, the illustrated components can perform other functions without departing from the scope of the specification and claims herein.

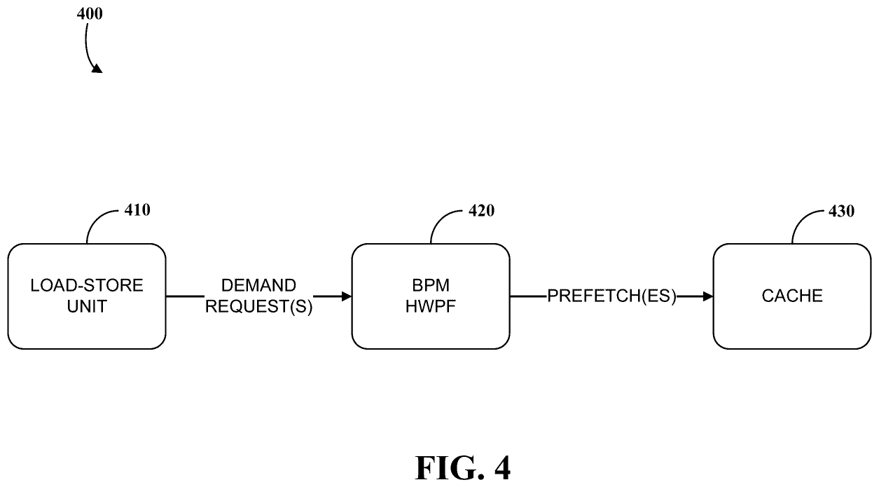

FIG. 4 is a block diagram of an example of a system 400. The system 400 includes a load-store unit 410 connected to a BPM HWPF 420, which in turn is connected to a cache 430. The processing system 400 can implement the methods and the hardware prefetchers described herein. In implementations, the load-store unit 410 can send demand request(s) to the BPM HWPF 420. The BPM HWPF 420 can use a pair of bit vectors, an access map and a prefetch map, to maintain state information for cache lines as described herein. Each bit is associated with a cache line. After collecting a defined number of demand requests, the access map can be analyzed to detect an access pattern as described herein. A prefetch request can be generated, sent to the cache 430, and a bit set in the prefetch map, accordingly. Confirmations can be determined from the access map and the prefetch map as described herein. Confirmations and mis-confirmations can be used to gauge aggressiveness and whether retraining is appropriate, respectively. A mis-confirmation being a demand request that does not match the determined pattern or does not hit a prefetch map. That is, the incoming demand request has not hit a prefetch map. This means the BPM HWPF has not sent out a prefetch request. As noted herein, after a defined number of demand mis-confirmations, a retraining is triggered since the BPM HWPF current pattern is not matching with the incoming demand request.

The BPM HWPF described herein divides a memory address space into zones and subzones, where each subzone includes or maps to a certain number of cache lines. A bitmap structure is maintained where each cache line from the zone has an entry that records the past memory accesses. The past access pattern is analyzed by pattern matching logic to identify the pattern for potential future prefetching.

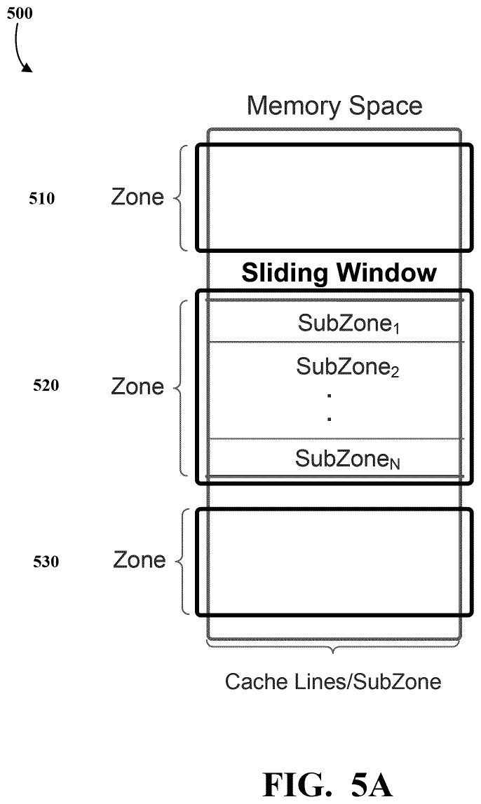

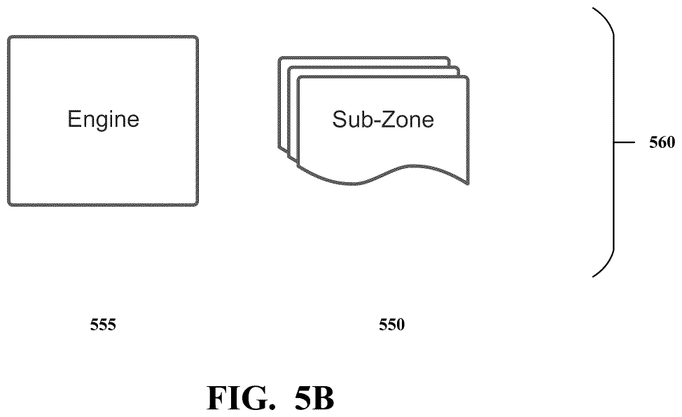

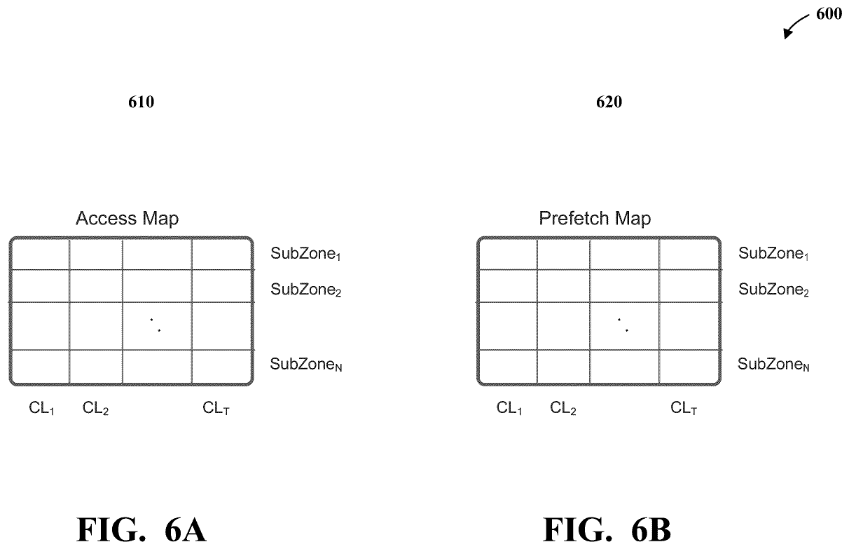

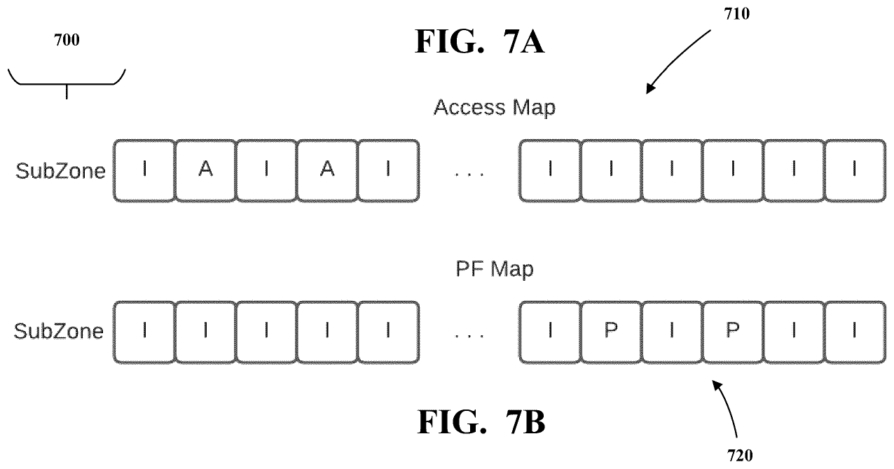

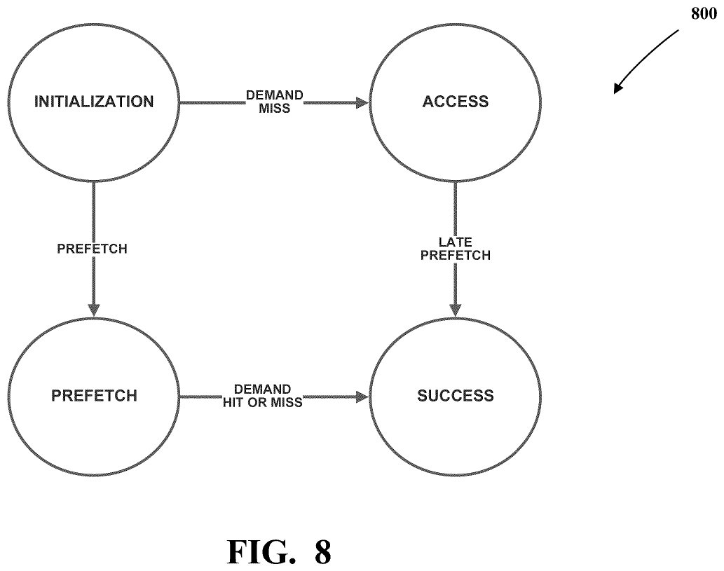

FIG. 5A is a diagram of a memory space 500, FIG. 5B is a block diagram of a prefetch engine 550 associated with a zone, FIGS. 6A and 6B are block diagrams of a bitmap structure 600, FIGS. 7A and 7B are block diagrams of an access map 710 and a prefetch map 720 for a subzone 700, and FIG. 8 is a state diagram 800 for the BPM HWPF.

The memory address space 500 is divided into a configurable number of memory regions called zones, e.g., zones 510, 520, and 530, using a sliding window of size ‘X’ KB. Each zone is further divided into a configurable number of subzones ‘N’. For example, zone 520 can have subzones 1 . . . N. In implementations, a zone can have 4 sequential in memory address space subzones (i.e., contiguous address space). Each subzone can include T cache lines (CL). For example, T can be 32. Each zone 550 has a prefetch engine 555 managing up to N subzones 560. Each subzone maintains a bitmap structure 600 to keep a history of incoming demand streams (where each stream consists of demand requests) and outgoing prefetch streams or prefetch requests. The bitmap structure 600 may include or be a pair of bitmaps such as an access map 610 and a prefetch map 620. As a demand and/or prefetch stream enters the next subzone, the prefetch engine will round-robin to select the next subzone. The new subzone is allocated or overwritten based on the available subzones.

As noted, a subzone 700 has an access map 710 and a prefetch map 720. An entry in the access map 710 and an entry in the prefetch map 720 represents a state of a cache line in the subzone. The access map 710 can keep track of accessed cache lines and the prefetch map 720 can keep track of prefetched cache lines. Each cache line can be in one of the following states: “Initial/Initialization”, “Prefetch”, “Access”, and “Confirmation”. A state diagram 800 is shown in FIG. 8. When the memory space 500 is mapped to a subzone, entries in both bitmaps are initialized to the “Initial/Initialization” (I) state. When a prefetch request is issued to a cache line, an entry in the prefetch map 720 corresponding to the cache line is set to or transitions to indicate the “Prefetch” state (P). When a demand request for a cache line is seen (a miss in the cache), an entry in the access map 710 corresponding to the cache line is set to or transitions to indicate the “Access” state (A).

In implementations, the BPM HWPF may not maintain a bitmap to identify the “Confirmation” state. The “Confirmation” state can be generated by using a bit location for a respective cache line in both bitmaps. The “Confirmation” state helps to reduce the duplicate demand request, reduces the duplicate prefetches from clogging the memory subsystem, and maintains the dynamic distance (aggressiveness). In implementations, when a demand request for a cache line is seen (a hit or a miss in the cache) for a cache line in the “Prefetch” state, then the state for that cache line is deemed to be in the “Confirmation” state. In implementations, when a prefetch request is issued to a cache line for a cache line in the “Access” state, then the state for that cache line is deemed to be in the “Confirmation” state. In implementations, this may be termed a late prefetch request and is not sent to the system.

In implementations, the BPM HWPF may include and/or use, but is not limited to, a set of configurable parameters as shown in Table 1:

TABLE 1

| KNOB | DESCRIPTION |
|---|---|
| zoneSize | Number of cache lines per zone |
| nCacheLinePerSubzone | Number of cache lines per subzone |
| patternSize | Maximum pattern size in bits to detect |
| retrainCount | Maximum demand mis-confirmation before |
| | retrain |
| aggrThrd | Threshold to increase the aggressiveness |

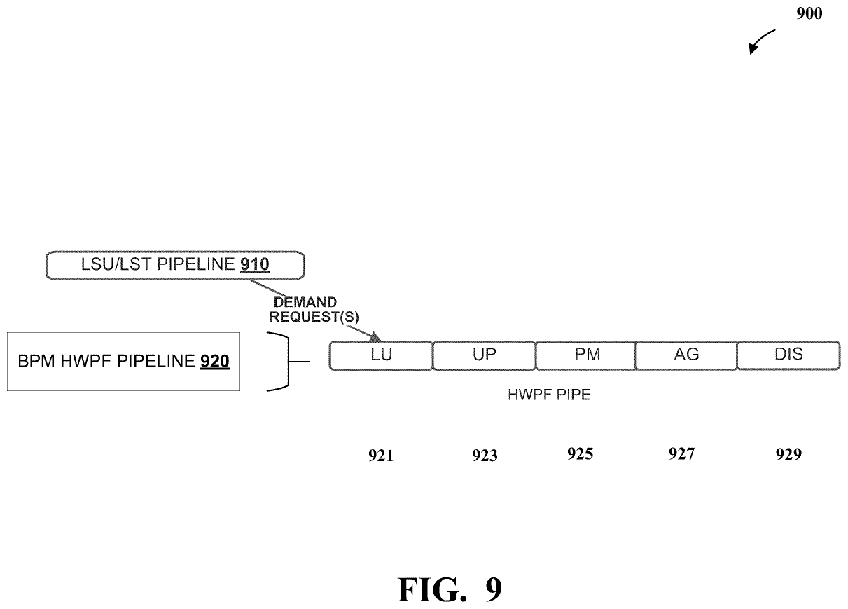

FIG. 9 is a block diagram showing an example of a system 900 which includes a load/store pipeline 910 for a load-store unit connected to a BPM HWPF pipeline 920 for a BPM HWPF. The BPM HWPF pipeline 920 can include, but is not limited to, a lookup stage (LU) 921, an update stage (UP) 923, a pattern match stage (PM) 925, an address generation stage (AG) 927, and a dispatch stage (DIS) 929. The LU stage 921 can compare training events with existing HWPF engines and generate a match vector to be used in the UP stage 923 on each HWPF engine. The UP stage 923 can update the access bit pattern i.e., access map, allocate a new entry, and prepare the bitmap for the PM stage 925. The PM stage 925 can perform the pattern matching operation. The AG stage 927 can take the matched pattern from the PM stage 925 and generate the next prefetch address. The DIS stage 929 can update the prefetch bit pattern i.e., prefetch map, and send the prefetch request to a HWPF issue queue. Each of stages perform as described herein. The BPM HWPF is integrated to or with the load-store unit. The load/store pipeline 910 can provide the demand requests and information about the cache hit/miss and other related information to train the BPM HWPF via processing through the BPM HWPF pipeline 920 as described herein. The system 900 and each component in the system 900 is illustrative and can include additional, fewer, or different components which may be similarly or differently architected without departing from the scope of the specification and claims herein. Moreover, the illustrated components can perform other functions without departing from the scope of the specification and claims herein.

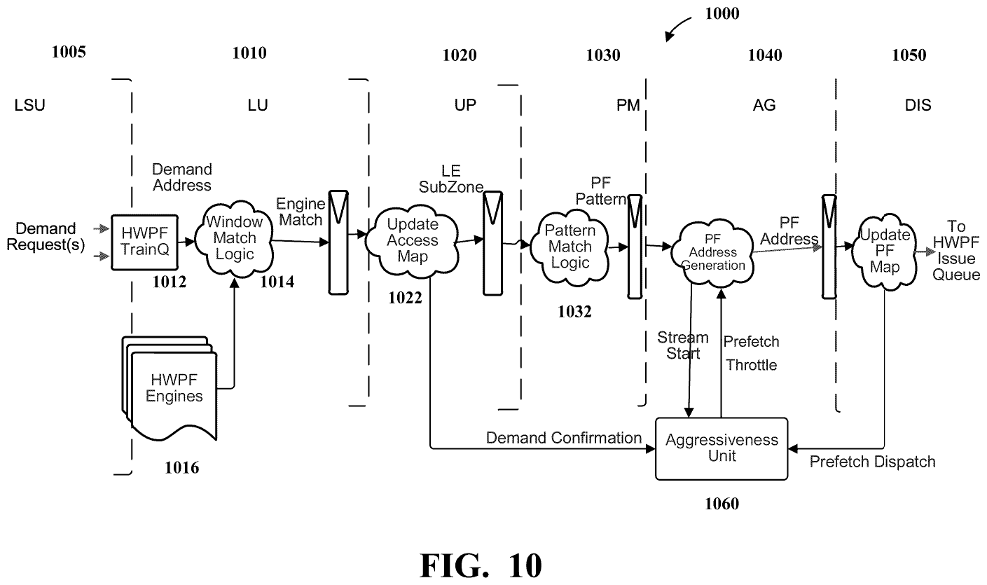

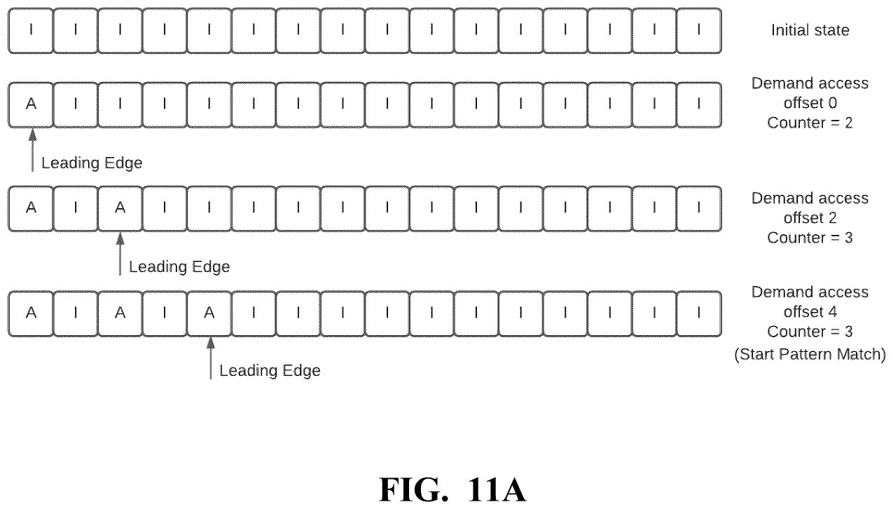

FIG. 10 is a block diagram showing an example of a BPM HWPF pipeline 1000 for a BPM HWPF. The BPM HWPF pipeline 1000 can include, but is not limited to, a LU stage 1010, an UP stage 1020, a PM stage 1030, an AG stage 1040, and a DIS stage 1050. The BPM HWPF pipeline 1000 is fed demand requests from a LSTC 1005 in a load/store pipeline. The BPM HWPF pipeline 1000 and each component in the BPM HWPF pipeline 1000 is illustrative and can include additional, fewer, or different components which may be similarly or differently architected without departing from the scope of the specification and claims herein. Moreover, the illustrated components can perform other functions without departing from the scope of the specification and claims herein.

In the LU stage 1010, a HWPF train queue circuit (HWPF TrainQ) 1012 can filter multiple demand requests (load or store) from the LSTC 1005. The redundant cache lines are removed from the training path. The HWPF TrainQ 1012 can perform the filtering before enqueuing the filtered or remaining demand requests. A window match logic 1014 in the BPM HWPF can compare the training events (i.e., the filtered demand requests) with existing HWPF engines 1016 and generate a match vector that is used in the UP stage 1020 for each HWPF engine. That is, the HWPF TrainQ 1012 can dequeue a demand request for a cache line. This demand request can be matched against each HWPF engine 1016 to determine if a subzone is already established. If none of the HWPF engines 1016 match, a new zone is established by the first invalid engine and then by pseudo Least Recently Used (PLRU) in the event all engines are being used. The selected engine is reset and re-initialized with the demand request as the first and only accessed cache line. If one of the HWPF engines 1016 does match, the matched HWPF engine can compare an address of the demand request against all the subzones to find which memory range it belongs to (noting that each subzone maintains the access map for a defined memory range). In an example, the defined memory range can be 2K. If a subzone match is found, the BPM HWPF in the UP stage 1020 can update the access map for the matched subzone. If a subzone match is not found, a new subzone is created or the oldest valid subzone is replaced.

In the UP stage 1020, the BPM HWPF can update information for the subzone which matches the demand request. The information for the subzone can include, but is not limited to, the access map (e.g., an appropriate bit position), the leading edge (LE) pointer, and the direction counter. A retrain signal can be generated and sent when a defined number of demand mis-confirmations have occurred. The BPM HWPF can prepare the access map or bitmap for the PM stage 1030. The input to UP stage 1020 is the demand request address and HWPF engine match information from the LU stage 1010.

In implementations, a defined number of demand requests are needed before the pattern match logic starts looking for a repeated pattern. Each subzone in an engine can detect a pattern as described herein. Each engine, however, will prefetch on one detected pattern based on subzone where the most recent demand request was seen or matched. In implementations, at least 3 demand request misses are needed and tracked to initiate pattern matching on a subzone. Upon determining a first demand request miss, a prefetch engine is allocated (a new zone) and a subzone is allocated in the zone. In implementations, this is done by the window match logic 1014 in the BPM HWPF. The subzone has an access map and a prefetch map. The first demand request miss is an anchor point for the access map. Upon determining a second demand request miss (i.e., where the window match logic 1014 determines the prefetch engine and subzone), the BPM HWPF can calculate or determine a magnitude (+/−) based on an address of the current demand request miss and the anchor point to identify the direction of the incoming demand stream. Upon determining a third demand request miss (i.e., where the window match logic 1014 determines the prefetch engine and subzone), the BPM HWPF can confirm the direction of the incoming demand stream. In implementations, the BPM HWPF can use a 2-bit saturating counter or direction counter to track the three demand request misses. As described herein, the PM stage 1030 can determine or detect a pattern once at least 3 demand request misses are encountered. In implementations, the BPM HWPF can use a retrain counter (retrainCount) in the PM stage 1030 to initiate subsequent retraining based on a define number of demand request mis-confirmations.

In the UP stage 1020, access map logic 1022 in the BPM HWPF can update the access map. The access map maintains a bitmap structure of all demand accesses to the prefetch engine. The history of demand accesses (demand request misses) is used to find a pattern for generating and sending prefetch requests. In implementations, the access map can be updated to track a cache line if the demand request matches a prefetch engine and if the demand request is a cache miss (e.g., a L1 cache miss). In implementations, the access map can be updated to track a cache line if the demand request matches a prefetch engine, the demand request is a cache hit (e.g., a L1 cache hit), and if the prefetch engine is trained. In the event the demand request is a hit and the prefetch engine is not trained this can lead to prefetching an address that already exists in the cache. Hence, the access map is not updated on a demand request hit when the prefetch engine is not trained.

In the UP stage 1020, the BPM HWPF can determine demand confirmations for a demand stream by referring to the bit map structures. A demand request is confirmed if the incoming demand stream hits the prefetch map i.e., the prefetch request to the incoming demand request address was already sent out. A demand confirmation is a prefetch usefulness metric. Demand confirmations are sent to an aggressiveness unit 1060, which is maintains prefetch distance and aggressiveness as discussed herein. If the BPM HWPF gets a defined number of demand mis-confirmation (retrainCount) this will force the BPM HWPF to retrain the engine in question. That is, the BPM HWPF can maintain demand mis-confirmations (i.e., retrain counter) on a per engine basis.

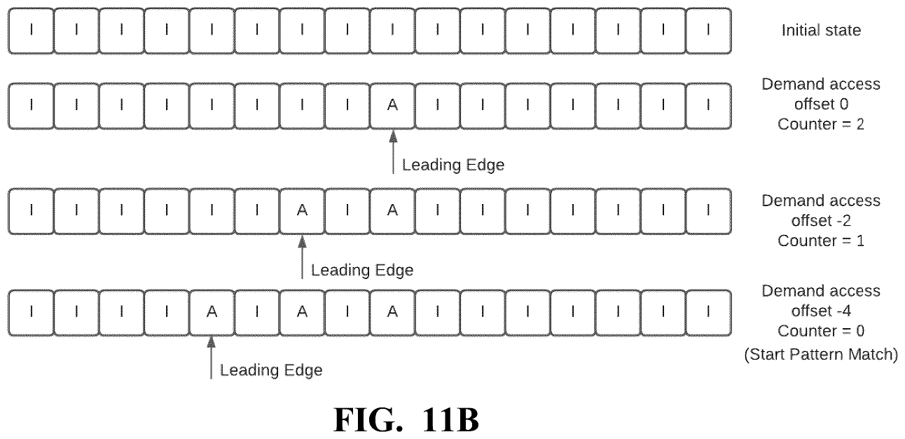

In the UP stage 1020, the BPM HWPF can determine a stream direction and Leading Edge (LE) identification. This is discussed with reference also to FIGS. 11A and 11B, which are examples of leading edge determinations from a rightmost edge and from a leftmost edge, respectively.

A 2-bit saturating counter or direction counter (per subzone in a prefetch engine) is used to identify the direction of the demand stream. The counter is default set to 2 as a weak positive. Weak negative and strong negative implies a negative direction stream while weak positive and strong positive implies a positive direction stream. Initially, the access map is set to I (initialization state). The first demand request, which is the anchor point (per subzone), is used to determine the direction (+/−) of the counter.

In FIG. 11A, the first demand request may have an address offset of 0. A second demand request may have an address offset of 2. The second demand request is compared with the anchor point address of the subzone and based on the magnitude, a direction of the counter is determined. A positive direction increases the counter and therefore, the counter is increased to 3. A third demand request may have an address offset of 4. The third demand request is compared with the anchor point address of the subzone to confirm the direction indicated by the counter. The LE is the most recent demand request in the direction of the demand stream. In the instance of a positive direction, the LE is the rightmost demand request. Since the subzone of the LE gives the most recent access history, LE's subzone is forwarded to the PM stage 1030 to identify the pattern. At this point, pattern matching may be initiated.

In FIG. 11B, the first demand request may have an address offset of 0. A second demand request may have an address offset of 2. The second demand request is compared with the anchor point address of the subzone and based on the magnitude, a direction of the counter is determined. A negative direction decreases the counter and therefore, the counter is decreased to 1. A third demand request may have an address offset of 4. The third demand request is compared with the anchor point address of the subzone and based on the magnitude, a direction of the counter is determined. A negative direction decreases the counter and therefore, the counter is decreased to 0. Again, the LE is the most recent demand request in the direction of the demand stream. In the instance of a negative direction, the LE is the leftmost demand request. Since the subzone of the LE gives the most recent access history, LE's subzone is forwarded to the PM stage 1030 to identify the pattern. At this point, pattern matching may be initiated.

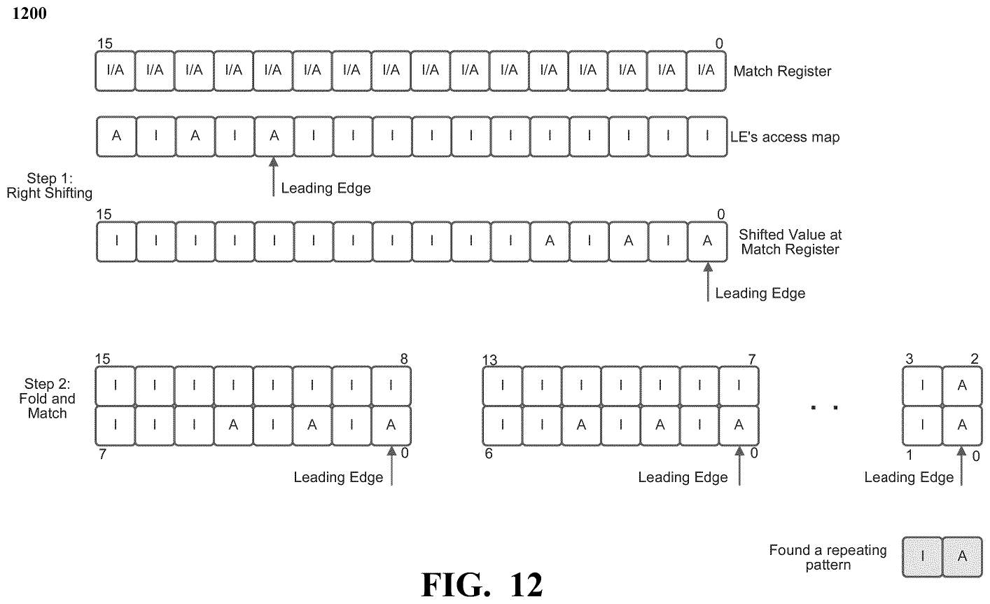

In the PM stage 1030, the BPM HWPF can perform the pattern matching operation as described herein. This is discussed with reference also to FIG. 12, which is an example of a block diagram for finding a repeating pattern. In implementations, pattern matching is performed in the access map in the subzone. In implementations, cross-subzone matching is not performed. However, once the pattern is matched, prefetching is allowed across the subzones. Input to PM stage 1030 can include the access map information of the LE's subzone from the UP stage 1020, demand miss counter, demand confirmation, and demand mis-confirmation to maintain the retrain counter. That is, the retrain counter is updated in the PM stage 1030. The outputs from PM stage 1030 are the prefetch pattern of a determined pattern size bit width (patternsize) and the stream direction. As described, a 3 demand request miss count will trigger pattern matching logic 1032. Once the pattern is found, demand mis-confirmation is used to retrain. As the demand mis-confirmation reaches a retaining counter, the pattern match logic 1032 looks for a new pattern to replace the old pattern.

The pattern matching logic 1032 and/or the BPM HWPF can use a match register 1200 to determine a pattern. Access pattern from the LE's subzone is used to find a pattern to prefetch. The pattern matching logic 1032 captures repeated patterns by looking at the last patternsize*2 demand requests from the access map for a repeating pattern of length patternsize bit wide with a special case for a single stride, where only 3 sequential accesses are needed. Depending on the direction of the stream, the pattern matching logic 1032 and/or the BPM HWPF prepares the match register 1200 with the last patternsize*2 demand requests to find the pattern.

For the right leading edge i.e., the access pattern with a positive stride, the access map of the LE's subzone is left-shifted to align with the patternsize*2 bit wide match register and reversed such that the leading edge is on the right side. For the left leading edge i.e., the access pattern with a negative stride, the access map of the LE's subzone is right-shifted to align with the patternsize*2 bit wide match register 1200. This process of shifting helps to simplify the pattern matching logic. FIG. 12 shows this process for identifying an 8-bit pattern in step 1. The pattern matching logic 1032 and/or the BPM HWPF looks for the pattern of patternsize bit all the way down to 2 bit and a unit stride pattern. Unit stride is considered a special case and it is handled accordingly.

To find an N-bit repeating pattern, [2*N−1, 0] bit from the match register 1200 is divided in half and compared to find a repeating pattern in both halves. The pattern matching logic 1032 and/or the BPM HWPF checks from patternsize bit pattern all the way to the unit stride pattern to find the match. 3 consecutive access patterns are used to identify the unit stride pattern. The pattern matching logic 1032 uses a priority-multiplexor to implement a selection policy, where the priority order is from patternsize bit pattern (highest) to unit stride (lowest).

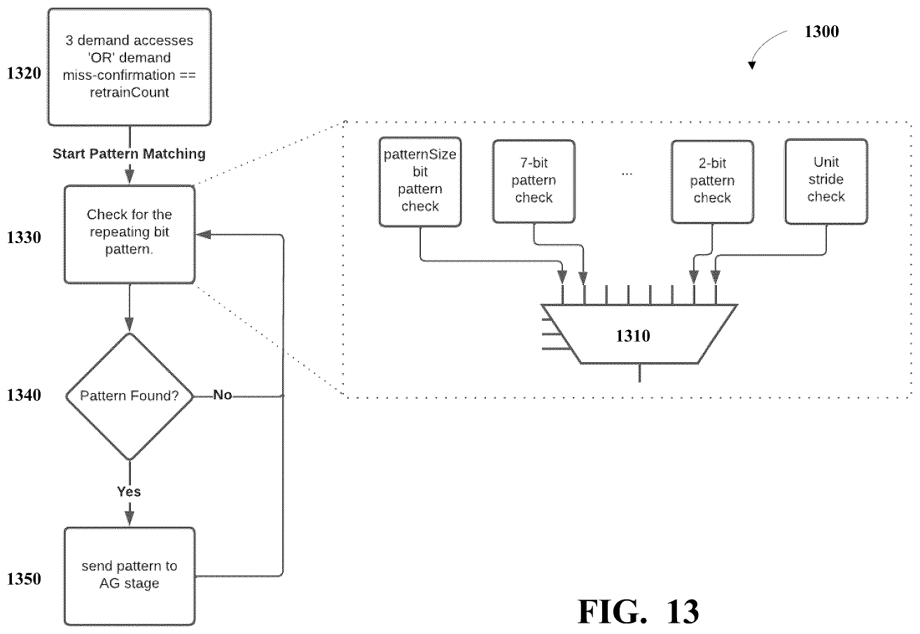

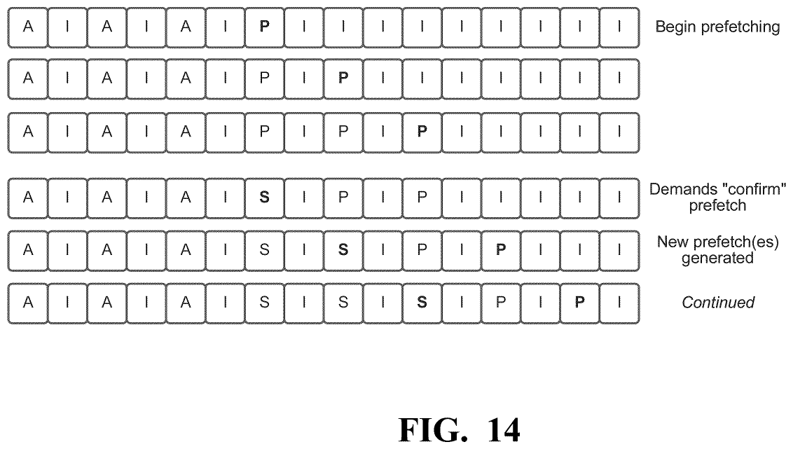

FIG. 13 is an example of a flow 1300 for pattern selection, which shows a priority-multiplexor 1310. The pattern matching logic 1032 can initiate pattern matching once a defined number of demand request misses occur or upon a defined number of demand request mis-confirmations (i.e., meeting or exceeding a retrain counter) (1320). The pattern matching logic 1032 can check for repeating bit patterns subject to a selection policy implemented by the priority-multiplexor 1310 (1330). If no pattern is found (1340), the pattern finding process is repeated (NO path). If a pattern is found (1340), the pattern is sent to the AG stage 1040 (1350) and the pattern process is repeated to find longer bit patterns (YES path).

The AG stage 1040 takes in the matched pattern and a stream direction from the PM stage 1030 and generates the next prefetch address based on the prefetch pattern, prefetch distance (or prefetch distance counter), and direction of the stream. The prefetch distance is how far ahead the prefetches are relative to the demand stream. The prefetch pattern identified from the PM stage 1030 is repeatedly used to generate the next prefetch address (in a positive or negative direction depending on the stream direction) until a new pattern and direction are identified in PM stage 1030. The next prefetch address is checked against the prefetch map to make sure the address was not already sent to prefetch. In implementations, a new prefetch address is generated every cycle. Address generation can halt due to the backpressure from the DIS stage 1050 because the HWPF issue queue is not ready, a fullness threshold has been reached with respect to the cache as described in PCT Application No. WO2023287512A1, filed Jun. 3, 2022, and entitled “Prefetcher with multi-cache level prefetches and feedback architecture”, the contents of which are incorporated herein by reference, and/or an aggressiveness threshold has been reached as indicated by the aggressiveness unit 1060.

The aggressiveness unit 1060 is responsible for dynamically maintaining the prefetch distance (or prefetch distance counter) and aggressiveness. The aggressiveness unit 1060 receives input from the UP stage 1020, the AG stage 1040, and the DIS stage 1050 to dynamically maintain a prefetch distance of the prefetch address generation. The prefetch distance is based on the bit map structure, a value of an aggressiveness counter as maintained in the aggressiveness unit 1060, and an aggressiveness threshold. The aggressiveness counter is increased on a demand request confirmation or increased on a late prefetch. These conditions happen once per cache line and duplicate cache lines are filtered out by the bit maps. That is, the incrementing of the aggressiveness counter happens once per cache line that is not a duplicate. If the aggressiveness counter reaches a confirmation threshold, a prefetch distance is incremented by 1 until the prefetch distance meets an exponential threshold. The aggressiveness counter is then reset. After meeting the exponential threshold, the prefetch distance doubles every time the aggressiveness counter reaches the confirmation threshold. The aggressiveness threshold is used to maintain no more than a defined prefetch distance between the demand stream and the prefetch stream.

In some cases, the BPM HWPF may lock onto a pattern and prefetch more cache lines than needed, resulting in more prefetches than demand confirmations. This is referred to as leaking credits and causes the head of the demand stream to catch up or pass the prefetch stream. Retraining the BPM HWPF can help, but sometimes it cannot find a better pattern and the issue persists. To avoid this problem, the current prefetch distance counter needs to be adjusted by sampling a subzone when it is about to be evicted. This is done by evaluating leaked credits=#prefetches-#demands (for only cases demands>0) and maintaining an accumulative value in a sample counter. When the value of the sample counter reaches a defined sample update threshold (which is configurable), the current prefetch distance counter is adjusted by the value of the sample counter to allow more prefetch requests to go through. This allows the prefetch requests to be ahead of the demand stream. A bit associated with each subzone is used to ensure that the subzone being evicted is part of the latest trained pattern, and the leaked credits are evaluated if the bit is set.

The DIS stage 1050 updates the prefetch bit pattern i.e., prefetch map (e.g., appropriate bit position), and sends the PF request to the HWPF issue queue. The input to the DIS stage 1050 is the prefetch address generated from the AG stage 1040.

As noted, the prefetch map maintains the bitmap structure of all the prefetch requests dispatched to the HWPF issue queue. The history of the prefetch request is required to avoid a duplicate prefetch request, identify demand confirmation, and identify late prefetch. Each subzone maintains the prefetch map for a defined memory range. In implementations, the defined memory range is 2K. When a valid prefetch address is generated, it is compared against all the subzones to find which memory range it belongs to. If the match is found, the respective prefetch map is updated. If a match is not found, a new subzone is created or the oldest valid subzone is replaced. The prefetch map is updated when the address is dispatched to the HWPF issue queue.

FIG. 14 is an example of a block diagram for sending prefetch requests and getting confirmations based on a found pattern. The pattern in this instance is “IA”. Prefetches are sent out in the same pattern “IP”, “IP”, etc. A demand request is shown to confirm a sent prefetch request with a “S”. Additional prefetch requests are sent and additional confirmations are received. This continues until a retraining event occurs and/or prefetching is halted as described herein.

The BPM HWPF operates on a single-level prefetching mode. In single-level prefetching, the BPM HWPF will generate only prefetch per cache line, and the level is determined by the load-store unit. If the BPM HWPF cannot allocate an L1 miss status holding registers (MSHR) (e.g., no MSHR free, MSHR utilization is too high for prefetches) for a prefetch request, then the prefetch request will be auto-converted into a L2 prefetch request and sent to the L2 cache. If at any time a prefetch request cannot be allocated, the prefetch request will be replayed at a later time.

Described herein is a system which performs bit pattern matching. In implementations, a processing system includes a load-store unit and a prefetcher connected to the load-store unit. The prefetcher includes a plurality of prefetch engines, where each prefetch engine is associated with a zone, each zone has a plurality of subzones, and each subzone has a plurality of cache lines, and an access map for each subzone, wherein each bit position represents a cache line in the plurality of cache lines. The prefetcher is configured to determine whether a demand request matches one of the plurality of prefetch engines, update, with respect to the demand request, a bit position in an access map for a subzone in a matching prefetch engine, determine a pattern from an access map for a subzone when a defined number of demand requests have been matched to the subzone, and generate a prefetch request based on at least the determined pattern.

In implementations, the prefetcher further includes a prefetch map for each subzone, wherein each bit position represents a cache line in the plurality of cache lines, and wherein the prefetcher is configured to update, with respect to a generated prefetch request, a bit position in a prefetch map for a subzone in a matching prefetch engine. In implementations, the prefetcher is further configured to allocate a prefetch engine and a subzone for a first demand request, wherein the first demand request is an anchor point for an associated access map, identify a direction of a demand request stream based on a second demand request and the anchor point, and confirm the direction of the demand request stream based on a third demand request. In implementations, the prefetcher is further configured to determine a leading edge pointer based on a most recent demand request in the direction of the demand request stream, shift subzone associated with the leading edge pointer to align the leading edge pointer in a match register, divide the match register evenly, compare one half to other half to find a pattern, and repeat the divide and compare for a decremented number of bits. In implementations, the bit position in the access map is updated when the demand request is a cache miss. In implementations, the bit position in the access map is updated when the demand request is a cache hit and a matching prefetch engine is trained, where a trained prefetch engine is prefetching based on a determined pattern. In implementations, the prefetcher is further configured to determine a demand confirmation when a demand request hits a prefetch map. In implementations, the prefetcher is further configured to maintain a counter for number of demand confirmations for each prefetch engine, and increase a prefetch distance for a prefetch engine when the counter meets a threshold, where the prefetch distance determines how far ahead a prefetch request stream is relative to an associated demand stream. In implementations, the prefetcher is further configured to determine a demand mis-confirmation when a demand request misses a prefetch map, and retrain a prefetch engine with another pattern when a number of demand mis-confirmations meets a threshold. In implementations, the prefetcher is further configured to process out-of-order demand requests.

Described herein is a method which performs bit pattern matching. The method includes determining, by a prefetcher, whether a demand request matches one of a plurality of prefetch engines, wherein each prefetch engine is associated with a zone, each zone has a plurality of subzones, each subzone has a plurality of cache lines and an access map, and each bit position in the access map represents a cache line, updating, by the prefetcher, with respect to the demand request, a bit position in an access map for a subzone in a matching prefetch engine, determining, by the prefetcher, a pattern from an access map for a subzone when a defined number of demand requests have been matched to that subzone, and generating, by the prefetcher, a prefetch request based on at least the determined pattern.

In implementations, the method further includes updating, by the prefetcher, with respect to a generated prefetch request, a bit position in a prefetch map for a subzone in a matching prefetch engine, wherein all subzones have a prefetch map and each bit position represents a cache line. In implementations, the method further includes allocating, by the prefetcher, a prefetch engine and a subzone for a first demand request, wherein the first demand request is an anchor point for an associated access map, identifying, by the prefetcher, a direction of a demand request stream based on a second demand request and the anchor point, and confirming, by the prefetcher, the direction of the demand request stream based on a third demand request. In implementations, the method further includes determining, by the prefetcher, a leading edge pointer based on a most recent demand request in the direction of the demand request stream, shifting, by the prefetcher, a subzone associated with the leading edge pointer to align the leading edge pointer in a match register, dividing, by the prefetcher, the match register evenly, comparing, by the prefetcher, one half to other half to find a pattern, and repeating, by the prefetcher, the divide and compare for a decremented number of bits. In implementations, the bit position in the access map is updated when the demand request is a cache miss. In implementations, the bit position in the access map is updated when the demand request is a cache hit and a matching prefetch engine is trained, where a trained prefetch engine is prefetching based on a determined pattern. In implementations, the method further includes determining, by the prefetcher, a demand confirmation when a demand request hits a prefetch map, maintaining, by the prefetcher, a counter for number of demand confirmations for each prefetch engine, and increasing, by the prefetcher, a prefetch distance for a prefetch engine when the counter meets a threshold, wherein the prefetch distance determines how far ahead a prefetch request stream is relative to an associated demand stream. In implementations, the method further includes determining, by the prefetcher, a demand mis-confirmation when a demand request misses a prefetch map, and retraining, by the prefetcher, a prefetch engine with another pattern when a number of demand mis-confirmations meets a threshold. In implementations, the prefetcher processes out-of-order demand requests.

Described herein is a prefetcher which performs bit pattern matching. The prefetcher includes a plurality of prefetch engines, where each prefetch engine is associated with a zone, each zone has a plurality of subzones, and each subzone has a plurality of cache lines, and an access map for each subzone, where each bit position represents a cache line in the plurality of cache lines. The prefetcher is configured to determine whether a demand request matches one of the plurality of prefetch engines, update, with respect to the demand request, a bit position in an access map for a subzone in a matching prefetch engine, determine a pattern from an access map for a subzone when a defined number of demand requests have been matched to the subzone, and generate a prefetch request based on at least the determined pattern.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A processing system, comprising:
a load-store unit; and
a prefetcher connected to the load-store unit, the prefetcher including:
a plurality of prefetch engines, wherein each prefetch engine is associated with a zone, each zone has a plurality of subzones, and each subzone has a plurality of cache lines; and
an access map for each subzone, wherein each bit position represents a cache line in the plurality of cache lines,
wherein the prefetcher is configured to:
determine whether a demand request matches one of the plurality of prefetch engines,
update, with respect to the demand request, a bit position in an access map for a subzone in a matching prefetch engine,
determine a pattern from an access map for a subzone when a defined number of demand requests have been matched to the subzone, and
generate a prefetch request based on at least the determined pattern.

2. The processing system of claim 1, wherein the prefetcher further comprises a prefetch map for each subzone, wherein each bit position represents a cache line in the plurality of cache lines, and wherein the prefetcher is configured to update, with respect to a generated prefetch request, a bit position in a prefetch map for a subzone in a matching prefetch engine.

3. The processing system of claim 1, wherein the prefetcher is further configured to:
allocate a prefetch engine and a subzone for a first demand request, wherein the first demand request is an anchor point for an associated access map;
identify a direction of a demand request stream based on a second demand request and the anchor point; and
confirm the direction of the demand request stream based on a third demand request.

4. The processing system of claim 3, wherein the prefetcher is further configured to:
determine a leading edge pointer based on a most recent demand request in the direction of the demand request stream;
shift subzone associated with the leading edge pointer to align the leading edge pointer in a match register;
divide the match register evenly;
compare one half to other half to find a pattern; and
repeat the divide and compare for a decremented number of bits.

5. The processing system of claim 1, wherein the bit position in the access map is updated when the demand request is a cache miss.

6. The processing system of claim 5, wherein the bit position in the access map is updated when the demand request is a cache hit and a matching prefetch engine is trained, where a trained prefetch engine is prefetching based on a determined pattern.

7. The processing system of claim 2, wherein the prefetcher is further configured to:
determine a demand confirmation when a demand request hits a prefetch map.

8. The processing system of claim 7, wherein the prefetcher is further configured to:
maintain a counter for number of demand confirmations for each prefetch engine; and
increase a prefetch distance for a prefetch engine when the counter meets a threshold, wherein the prefetch distance determines how far ahead a prefetch request stream is relative to an associated demand stream.

9. The processing system of claim 2, wherein the prefetcher is further configured to:
determine a demand mis-confirmation when a demand request misses a prefetch map; and
retrain a prefetch engine with another pattern when a number of demand mis-confirmations meets a threshold.

10. The processing system of claim 1, wherein the prefetcher is further configured to process out-of-order demand requests.

11. A method, comprising:
determining, by a prefetcher, whether a demand request matches one of a plurality of prefetch engines, wherein each prefetch engine is associated with a zone, each zone has a plurality of subzones, each subzone has a plurality of cache lines and an access map, and each bit position in the access map represents a cache line;
updating, by the prefetcher, with respect to the demand request, a bit position in an access map for a subzone in a matching prefetch engine;
determining, by the prefetcher, a pattern from an access map for a subzone when a defined number of demand requests have been matched to that subzone; and
generating, by the prefetcher, a prefetch request based on at least the determined pattern.

12. The method of claim 11, further comprising:
updating, by the prefetcher, with respect to a generated prefetch request, a bit position in a prefetch map for a subzone in a matching prefetch engine, wherein all subzones each have a prefetch map and each bit position represents a cache line.

13. The method of claim 11, further comprising:
allocating, by the prefetcher, a prefetch engine and a subzone for a first demand request, wherein the first demand request is an anchor point for an associated access map;
identifying, by the prefetcher, a direction of a demand request stream based on a second demand request and the anchor point; and
confirming, by the prefetcher, the direction of the demand request stream based on a third demand request.

14. The method of claim 13, further comprising:
determining, by the prefetcher, a leading edge pointer based on a most recent demand request in the direction of the demand request stream;
shifting, by the prefetcher, a subzone associated with the leading edge pointer to align the leading edge pointer in a match register;
dividing, by the prefetcher, the match register evenly;
comparing, by the prefetcher, one half to other half to find a pattern; and
repeating, by the prefetcher, the divide and compare for a decremented number of bits.

15. The method of claim 11, wherein the bit position in the access map is updated when the demand request is a cache miss.

16. The method of claim 11, wherein the bit position in the access map is updated when the demand request is a cache hit and a matching prefetch engine is trained, where a trained prefetch engine is prefetching based on a determined pattern.

17. The method of claim 11, further comprising:
determining, by the prefetcher, a demand confirmation when a demand request hits a prefetch map;
maintaining, by the prefetcher, a counter for number of demand confirmations for each prefetch engine; and
increasing, by the prefetcher, a prefetch distance for a prefetch engine when the counter meets a threshold, wherein the prefetch distance determines how far ahead a prefetch request stream is relative to an associated demand stream.

18. The method of claim 11, further comprising:
determining, by the prefetcher, a demand mis-confirmation when a demand request misses a prefetch map; and
retraining, by the prefetcher, a prefetch engine with another pattern when a number of demand mis-confirmations meets a threshold.

19. The method of claim 11, wherein the prefetcher processes out-of-order demand requests.

20. A prefetcher, comprising:
a plurality of prefetch engines, wherein each prefetch engine is associated with a zone, each zone has a plurality of subzones, and each subzone has a plurality of cache lines; and
an access map for each subzone, wherein each bit position represents a cache line in the plurality of cache lines,
wherein the prefetcher is configured to:
determine whether a demand request matches one of the plurality of prefetch engines,
update, with respect to the demand request, a bit position in an access map for a subzone in a matching prefetch engine,
determine a pattern from an access map for a subzone when a defined number of demand requests have been matched to the subzone, and
generate a prefetch request based on at least the determined pattern.
